(19) United States
(12) Patent Application Publication
(10) Pub. No.: US 2005/0247747 A1
(43) Pub. Date: Nov. 10, 2005

(54) Load carrier for use with a camper trailer

(76) Inventors: Scott L. Henry, Shorewood, MN (US); John M. Enga, Rogers, MN (US); Jeffrey S. Thiessen, Champlin, MN (US)

Correspondence Address: MOORE, HANSEN & SUMNER, PLLP, 225 SOUTH SIXTH ST, MINNEAPOLIS, MN, 55402, US

(21) Appl. No.: 10/838,825

(22) Filed: May 4, 2004

(51) Int. Cl. B60R 7/00; B60R 9/00; B60R 11/00

(52) U.S. Cl. 224/401

(57) ABSTRACT

A carrier for use with a camper trailer having a forwardly extending trailer tongue is described. The carrier includes a retainer assembly attached to a load support structure. The load support structure is configured to be operatively connected to the trailer tongue. The load support structure is vertically adjustable along a height dimension of the camper trailer. The retainer assembly is configured to releasably secure a load such that the load extends over the tongue and a top cover portion of the camper. In one embodiment, the retainer assembly is configured to secure one or more bicycles as the load.

### FIELD OF THE INVENTION

The present invention relates to devices that are used to temporarily attach an item to a vehicle so that the item can be transported from one location to another location. More particularly, the present invention relates to a carrier that may be used in conjunction with a trailer to transport one or more bicycles from one location to another location.

### BACKGROUND OF THE INVENTION

Bicycle racks or carriers have been used for many years as an adjunct to vehicles such as cars, which are not usually equipped for carrying bicycles. Some carriers are attachable to the front or rear end of a vehicle at its bumper and hold a bicycle so that it is generally parallel with the front or rear end of the vehicle, as the case may be. Other carriers are attachable to the roof of a vehicle and hold a bicycle so that it is generally parallel to the sides of the vehicle.

Unfortunately, the above-mentioned carriers are not desirable with vehicles such as camper trailers, and in particular trailers that are designed to partially collapse for travel. Such trailers, also known as folding tent trailers, frequently include a rigid, vertically adjustable top, one or more horizontal extensions, and flexible sides.

Some carriers exist for use with camper trailers as shown in U.S. Pat. No. 6,089,428 entitled “Bike Rack” filed Jul. 25, 1997 by Wagner and U.S. Pat. No. 6,092,706 entitled “B.C. Bicycle Rack” filed Jul. 15, 1999 by Bogan. However, these existing carriers are designed to carry one or two bicycles on a camper trailer. A need still exists for a bicycle carrier designed to accommodate more than two bicycles. Ideally such a carrier would carry the bicycles such that they extend over top of the camper trailer such that the bicycles or the carrier do not interfere with other items mounted on the tongue such as a propane tank, spare tire, battery or tongue support leg.

The present invention provides a solution to this and other problems, and offers other advantages over the prior art.

### BRIEF SUMMARY OF THE INVENTION

The present invention related to a carrier that solves the above-mentioned problems. In accordance with one embodiment of the invention, a carrier for use with a camper trailer having a forwardly extending trailer tongue is described. The carrier includes a retainer assembly attached to a load support structure. The load support structure is configured to be operatively connected to the trailer tongue. The load support structure is vertically adjustable along a height dimension of the camper trailer. The retainer assembly is configured to releasably secure a load such that the load extends over the tongue and a top cover portion of the camper. In one embodiment, the retainer assembly is configured to secure one or more bicycles as the load.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 is a perspective view of an embodiment of the present invention carrier as a bicycle carrier as it may be attached to a trailer.

FIG. 2 is a side elevation view of bicycle carrier of FIG. 1, in which the bicycle carrier has been lowered to allow the trailer to be expanded into a camping configuration.

FIG. 3 is a side elevation view of the bicycle carrier as it may be used to operatively connect a bicycle to a trailer.

FIG. 4 is a front elevation view of the bicycle carrier shown in FIG. 3.

FIG. 5 is a front elevation view of an embodiment of the bicycle carrier that has been lowered to allow the trailer to be expanded into a camping configuration.

FIG. 6 is a partial, perspective view of a load bar and an attachment collar of the bicycle carrier, taken from below and looking up.

FIG. 7 is a partial, perspective view of the load bar and an attachment collar of the bicycle carrier, taken from above and looking down.

FIG. 8 is a partial perspective view of an attachment bracket used to attach a bicycle carrier to a trailer.

FIG. 9 is a perspective view of an attachment bracket used to operatively connect a bike to the bicycle carrier.

FIG. 10 is a partial, side elevation view of the bicycle carrier showing attachment brackets that are operatively connected to a load bar.

### DESCRIPTION OF THE PREFERRED EMBODIMENTS

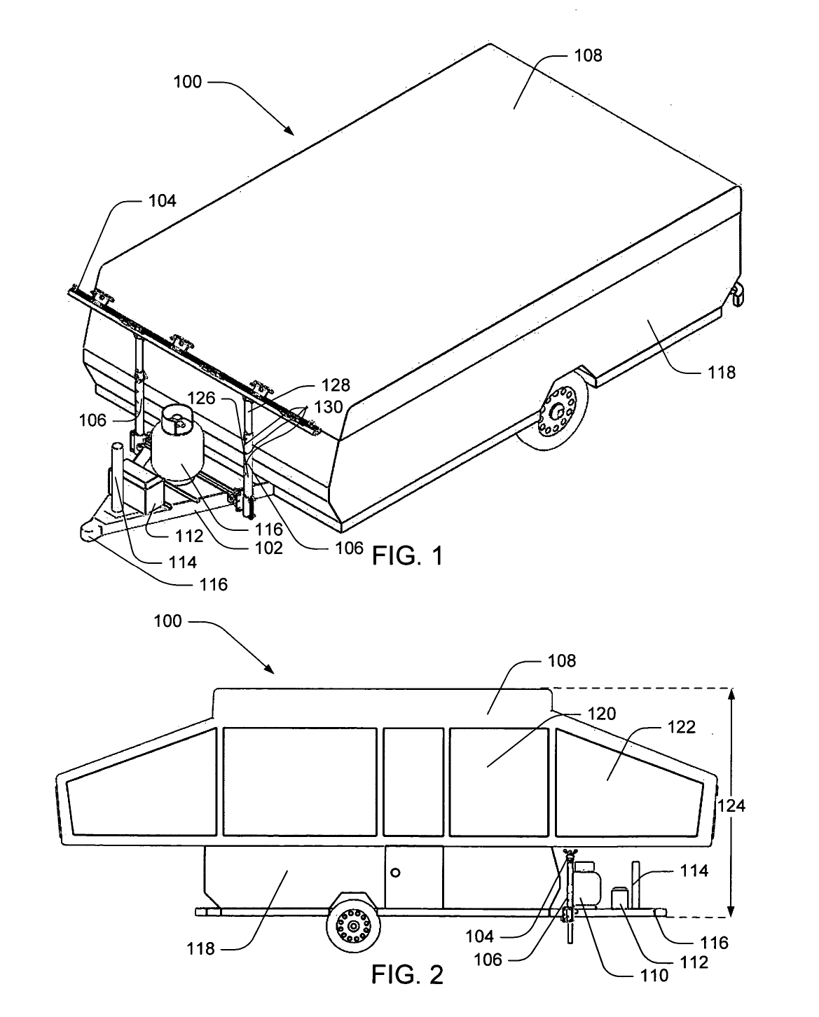

An embodiment of a load carrier of the present invention is shown in FIG. 1. Here, a camper trailer 100 in a travel configuration is shown. The camper trailer 100 is of the type having a trailer tongue 102, camper rigid top cover 108, and a camper tent lower section and storage 118. A preferred embodiment load carrier that has been optimized for use as a bicycle carrier is also shown in FIG. 1. The bicycle carrier has a retainer assembly 104 and load support structure 106. In addition, FIG. 1 also shows other items which optionally could be mounted on the tongue 102 such as a propane tank 110, battery 112, tongue support leg 114, and trailer coupler 116.

FIG. 2 is a side elevation view of the bicycle carrier of FIG. 1, in which the bicycle carrier has been lowered to allow the trailer to be expanded into a camping configuration. Camper top cover 108 has been raised to expose items stored in the camper tent section storage 118. In particular, the camper tent living quarters 120 is one such item that is stored in the storage 118. Top cover 108 also doubles as the top of the camper living quarters 120. When the camper trailer 100 is configured in the camping configuration, a front adjustable section 122 of the camper tent living quarters 120 can be folded out or extended over the trailer tongue 102.

Preferably load support structure 106 is vertically adjustable along a portion height dimension 124 of the camper trailer 100. Such vertical adjustment can be provided in a variety of manners. In a preferred embodiment, the load support structure 106 includes aluminum tubes 126 and 128 with differing diameters that permit tube 128 to slidably engage tube 126 by extending into the lumen of tube 126. As such, tubes 126 and 128 can telescopically adjust to a variety of positions along the camper trailer height dimension 124.

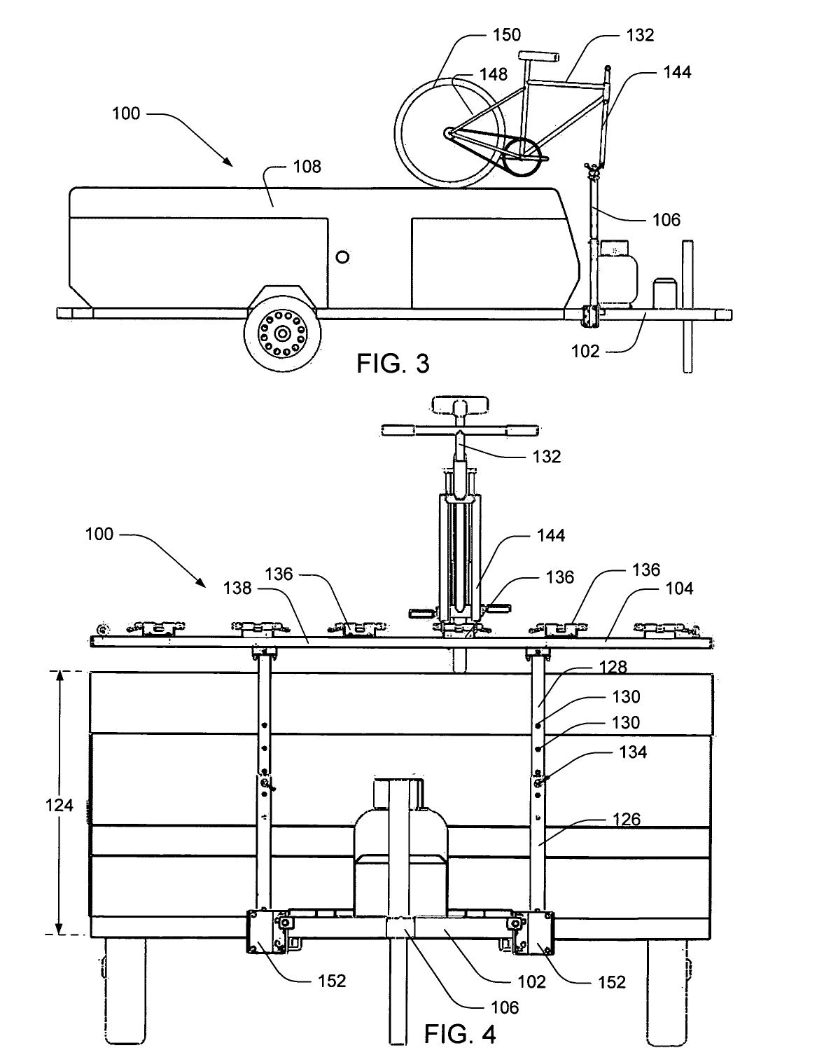

The tubes 126 and 128 include holes 130 through which a bolt or retainer clip (not shown) can be placed to hold the tubes at a desired height position. The load support structure 106 tubes 126 and 128 preferably can be held at least a lower height position as shown in FIG. 2 and a higher height position as shown in FIG. 3. The lower height position being low enough relative to the camper trailer height dimension 124 to permit the adjustable section 122 of the camper living quarters 120 to extend over the top of the load support structure 106. The higher height position being high enough relative to the camper trailer height dimension 124 to permit a load (e.g., a bicycle 132) to extend over the top of the top cover 108 when the camper trailer 100 is in the travel configuration.

It will be appreciated by those skilled in the art that other vertical adjustment mechanisms could be used to perform substantially the same height position adjustment with departing from the scope and spirit of the present invention. For example, a friction clamp could be used in place of the hole 130 and retainer clip combination. Also, the tubes 126 and 128 could have a cross-section profile shape that is round, square, hexagon, or some other shape that permits easy sliding engagement of the tubes. In addition, the telescoping tubes could be replaced by other forms of adjustable members such as a series of bars hinged together that can adjust to a variety of height positions.

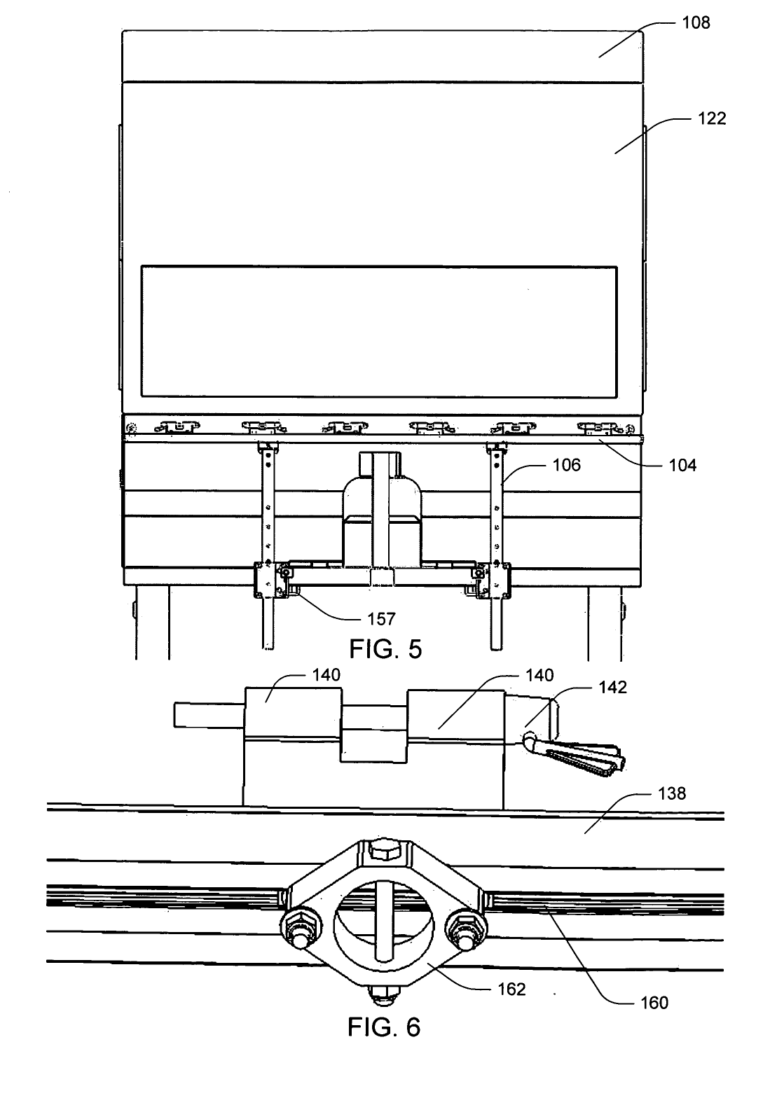

FIG. 5 is a front elevation view of the bicycle carrier in the same camping configuration shown in FIG. 2. In the front elevation view, the camper top cover 108 and front adjustable section 122 of the camper tent living quarters 120 is shown to be above the retainer assembly 104 and load support structure 106 that have been lowered relative to the trailer height dimension 124.

FIG. 3 is a side elevation view of the bicycle carrier as it may be used to operatively connect a bicycle 132 to a camper trailer 100 operatively configured in a travel configuration. FIG. 4 is a front elevation view of the same travel configuration of the bicycle carrier and camper trailer 100 shown in FIG. 3. Retainer assembly 104 preferably is configured to releasably secure a bicycle load 132 such that the bicycle load 132 extends over the tongue 102 and a top cover portion 108 of the camper trailer 100.

Preferably the bicycle 132 is carried in an upright position as shown in the figures. In this upright position, the rear tire 150 of the bicycle 132 could rest on the top cover portion 108 of the camper trailer 100. In addition, several yokes 136 can be spaced apart from one another as shown in FIG. 4. With several yokes on the load bar 138, one or more bicycles 132 can be secured to the retainer assembly 104 when the camper trailer 100 is configured in a travel configuration. Preferably, yokes 136 are mounted in an alternating pattern with the elongated members 140 canted forward towards the trailer tongue 102 and back away from the trailer tongue. By canting the yokes 136 forward and back, two or more bicycles can be mounted closer together in upright positions without having the pedals and handlebars of one bicycle interfering with another bicycle.

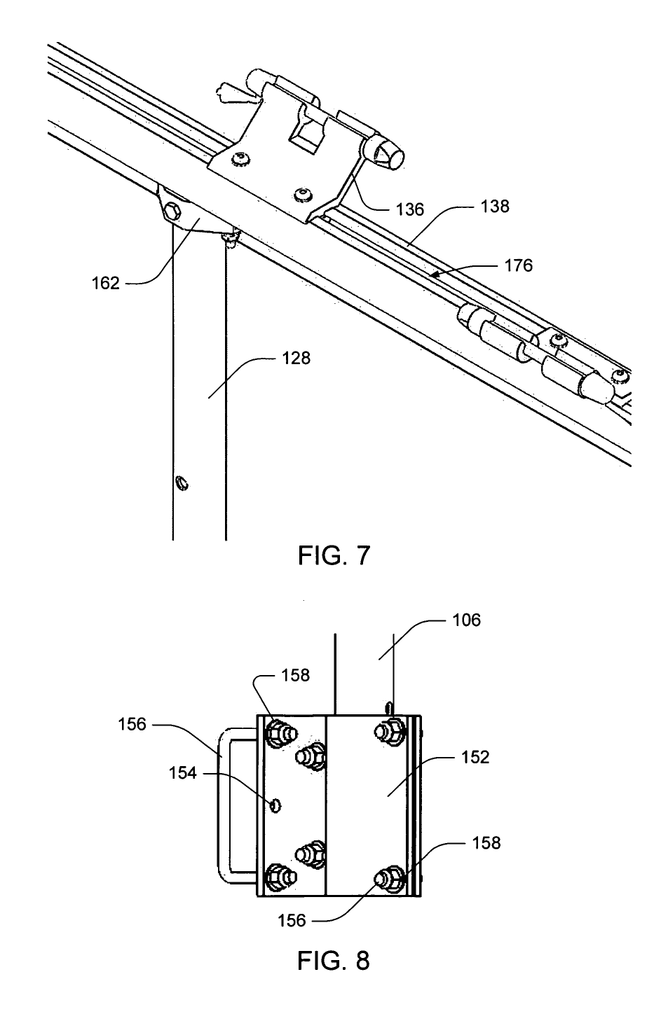

FIG. 6 is a partial, perspective view of a load bar 138 and an attachment collar 162 of the bicycle carrier, taken from below and looking up so that a channel 160 can be seen. Similarly, FIG. 7 is a partial, perspective view of the load bar 138 and an attachment collar 162 of the bicycle carrier, taken from above and looking down so that a channel 176 can be seen.

FIG. 8 is a partial perspective view of an mounting attachment bracket 152 used to attach a the load support structure 106, with U-bolt 156 to trailer tongue 102. The mounting bracket 152 has several holes bored there through which permit mounting of the bicycle carrier to trailer tongues 102 having a variety of tongue thicknesses. Mounting can be accomplished through a variety of means such as a pop rivet, stake weld, screw or, as shown, a U-bolt 156 and nut 158 combination.

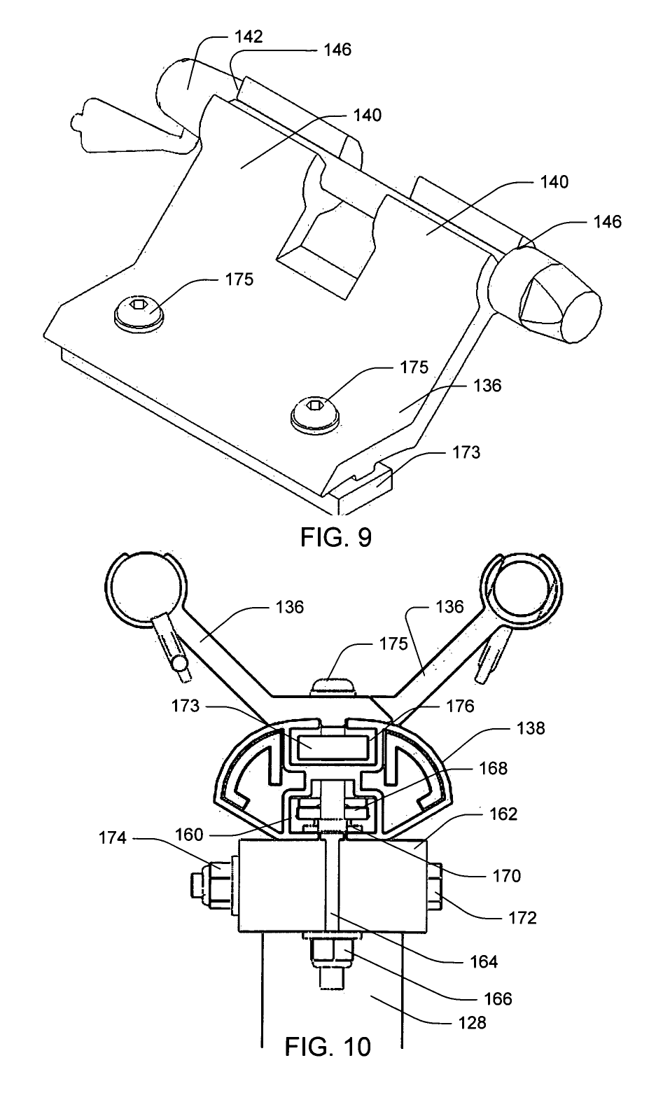

As shown in a perspective view in FIG. 9 and a partial, side elevation view in FIG. 10, retainer assembly 104 includes one or more attachment brackets or yokes 136 and a load bar 138. The yoke 136 has elongated members 140 which are configured as a holder that accepts the skewers 142 that normally are used to hold on the front tire of a bicycle 132. Ideally the elongated members 140 of the yoke are spaced apart such that a front wheel frame fork 144 of the bicycle 132 fits in the gap 146 between the elongated members 140 of the yoke 136 and the skewer 142 such that the frame fork 144 of the bicycle 136 can be secured to the retainer assembly 104. A typical bicycle 132 has a front 144 and a rear 148 wheel frame fork. It will be appreciated by those skilled in the art that while the preferred embodiment shown in the figures shows the front wheel frame fork 144 being secured to the retainer assembly 104, an alternative is to configure the retainer assembly to accept the rear wheel frame fork 148.

As shown in FIG. 10, attachment collar 162 is secured to tube 128 with a nut 174 and bolt 172. In addition, attachment collar 162 is secured to the load bar 138 by fitting a T-bolt head 168 of bolt 164 into a channel 160 formed in the load bar 138. Subsequently, a nut 166 is secured to the end of the bolt 164 which is opposite to the T-bolt head 168 Optionally, one or more washers 170 can be added to the nut 166 and bolt 164 combination to fill any extra spaces in the channel 160 between the T-bolt head 168 and the attachment collar 162. Ideally, the T-bolt head 168 and washers 170 snuggly fit into the channel 160 so that the bolt 164 may slide along the channel 160 without easily falling out of the channel. In a similar fashion, load bar 138 has a channel 176 on the opposite side of the load bar 138 from channel 160. Channel 176 is configured to accept one or more bolt heads 175 or T-shaped plate 173 that are used to secure one or more yokes 136 to the load bar 138. It will be appreciated by those skilled in the art that other attachment mechanisms can be used, such as T-bolts or J-bolts, in place of the T-shaped plate 173.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the load carrier while maintaining substantially the same functionality without departing from the scope and spirit of the present invention. In addition, although the preferred embodiment described herein is directed to a load carrier for a camper trailer, it will be appreciated by those skilled in the art that the teachings of the present invention can be applied to other types of trailers or campers without departing from the scope and spirit of the present invention.

1. A carrier for use with a camper trailer having a forwardly extending trailer tongue, the carrier comprising:
a load support structure configured to be operatively connected to the tongue, the load support structure being vertically adjustable along a height dimension of the camper trailer; and
a retainer assembly attached to the load support structure, the retainer assembly configured to releasably secure a load such that the load extends over the tongue and a top cover portion of the camper.

2. The carrier of claim 1, wherein the retainer assembly is operatively configured to accept a bicycle as the load.

3. The carrier of claim 2, wherein the retainer assembly comprises a yoke having elongated members and configured as a holder to engage a wheel frame fork of the bicycle between the elongated members of the yoke such that the frame fork of the bicycle can be secured to the retainer assembly.

4. The carrier of claim 3, wherein the bicycle comprises a front and a rear wheel frame fork and wherein the retainer assembly is operatively configured to releasably engage one of the front frame forks.

5. The carrier of claim 4, wherein the retainer assembly is operatively configured to releasably engage the wheel frame fork and secure the bicycle in an upright position.

6. The carrier of claim 4 wherein the retainer assembly comprises a plurality of yokes, the yokes being configured such that a plurality of bicycles can be secured to the retainer assembly when the camper trailer is configured in a travel configuration.

7. The carrier of claim 1, wherein the load support structure comprises at least a first and second tubular section which slidably engage each other to telescope into a plurality of positions to provide vertical adjustment of the load support structure along the height dimension of the camper trailer.

8. The carrier of claim 1, wherein the load support structure comprises an adjustable member that is configurable between a first and a second height position along the height dimension of the camper trailer.

9. The carrier of claim 8, wherein the camper top cover portion forms a top for camper living quarters, the camper living quarters having an adjustable section that can be extended over the trailer tongue in a camping configuration, the adjustable member first height position being low enough relative to the camper trailer height dimension to permit the adjustable section of the camper living quarters to extend over the top of the load support structure.

10. The carrier of claim 8, wherein the camper top cover portion forms a top for camper living quarters, the camper living quarters having an adjustable section that can be folded under the camper top cover portion in a travel configuration, the adjustable member second height position being high enough relative to the camper trailer height dimension to permit the load to extend over the top of the top cover portion when the camper trailer is in the travel configuration.

11. The carrier of claim 1 wherein the load support structure comprises a mounting bracket for coupling the carrier to the trailer tongue, the mounting bracket having a plurality of holes bored therethrough which permit mounting of the carrier to trailer tongues having a variety of tongue thicknesses.

12. A bicycle carrier for use with a camper trailer having a forwardly extending trailer tongue, the bicycle carrier comprising:
a load support structure configured to be operatively connected to the tongue, the load support structure having an adjustable member that is configurable between a first and a second height position along a height dimension of the camper trailer; and
a retainer assembly attached to the load support structure, the retainer assembly configured to releasably secure a bicycle such that the bicycle extends over the tongue and a top cover portion of living quarters of the camper, the camper living quarters having an adjustable section that can be extended over the trailer tongue in a camping configuration and folded under the camper top cover portion in a travel configuration.

13. The bicycle carrier of claim 12, wherein the retainer assembly comprises a yoke having elongated members and configured as a holder to engage a wheel frame fork of the bicycle between the elongated members of the yoke such that the frame fork of the bicycle can be secured to the retainer assembly.

14. The bicycle carrier of claim 12, wherein the bicycle comprises a front and a rear wheel frame fork and wherein the retainer assembly is operatively configured to releasably engage one of the front frame forks.

15. The bicycle carrier of claim 14, wherein the retainer assembly is operatively configured to releasably engage the wheel frame fork and secure the bicycle in an upright position.

16. The carrier of claim 14 wherein the retainer assembly comprises a plurality of yokes, the yokes being configured such that a plurality of bicycles can be secured to the retainer assembly when the camper trailer is configured in the travel configuration.

17. The carrier of claim 12, wherein the load support structure comprises at least a first and second tubular section which slidably engage each other to telescope into a plurality of positions to provide vertical adjustment of the load support structure along the height dimension of the camper trailer.

18. The bicycle carrier of claim 12, wherein the first height position of the load support structure adjustable member is low enough relative to the camper trailer height dimension to permit the adjustable section of the camper living quarters to extend over the top of the load support structure when the camper trailer is in the camping configuration.

19. The bicycle carrier of claim 12, wherein the second height position of the load support structure adjustable member is high enough relative to the camper trailer height dimension to permit the bicycle to extend over the top of the top cover portion when the camper trailer is in the travel configuration.

20. The bicycle carrier of claim 12 wherein the load support structure comprises a mounting bracket for coupling the bicycle carrier to the trailer tongue, the mounting bracket having a plurality of holes bored therethrough which permit mounting of the bicycle carrier to trailer tongues having a variety of tongue thicknesses.
